(19) United States
(12) Patent Application Publication
(10) Pub. No.: US 2001/0037466 A1
(43) Pub. Date: Nov. 1, 2001

(54) Network connection control method and connection control system

(75) Inventors: Shigeru Fukutake, Tokyo (JP); Munenori Ohtsuki, Tokyo (JP)

Correspondence Address: Jordan and Hamburg, 122 East 42nd Street, New York, NY, 10168, US

(73) Assignee: KONAMI CORPORATION

(21) Appl. No.: 09/844,049

(22) Filed: Apr. 27, 2001

(30) Foreign Application Priority Data
Apr. 28, 2000 (JP) 2000-131263

(51) Int. Cl. H04L 9/32

(52) U.S. Cl. 713/201

(57) ABSTRACT

The present invention is to provide a network connection control method capable of minimizing a cost when service is provided via Internet. User authentication information sent together with an Internet connection request from a user terminal 5 relevant to a NAS (Network Access Server) 6 managed by an access provider, is transferred to an authentication server 7 managed by the provider. When the user authentication information meets a predetermined condition, the user authentication information is transferred to an authentication server 10 managed by a service provider which is different from the provider. Then, user authentication is executed, referring to a database 15 associated with the authentication server 10, and the user authentication result is returned to the authentication server 7. The authentication server 7 notifies the authentication result to the NAS 6 from the authentication server 10. The NAS 6 controls whether the user terminal 5 enabled or disables connection to Internet 1 based on the result of the notified user authentication.

### BACKGROUND OF THE INVENTION

1. Field of the Invention

The present invention relates to an Internet connection control method and connection control system.

2. Description of the Related Art

In recent years, attention has been paid to commerce for providing a variety of services by utilizing a computer network. In particular, with the advancement of Internet, services targeted for individual consumers unfamiliar with a computer network are provided through a network, and commerce of such type is commonly known among such consumers.

In the meantime, in the case where individual users use the Internet, many of the users connect their own terminals to the Internet by utilizing a dialup IP connection service provided by commercially available providers. In this case, there has been a need for a user to make contract with a provider for Internet connection.

On the other hand, there exists an accounting problem with provision of service utilizing the Internet. As means for solving this problem, an enterprise providing charged service notifies an account code such as member's number to a user desiring services, restricts a user utilizing services based on this account code, and grasps an access state by each user, thereby invoicing an access charge.

In such a circumference, when a user who does not have Internet connection environment intends to utilize specific enterprise service, there is a need to make two contracts, i.e., a contract with a provider and a contract with an enterprise providing service over the network, which makes a user burdensome. For individual users who do not have sufficient knowledge concerning the Internet, the meaning of providers is hardly understood, and such users cannot often judge which provider may be chosen. In the case where accounting is performed separately for the Internet connection service and the service access over the network, and invoicing is performed separately, there is apprehension that individual users who do not have network knowledge are further confused.

On the other hand, if an enterprise who intends to provide any service over the Internet attempts to provide Internet connection service at the same time, there is a need to provide various access points, which makes equipment cost higher. Therefore, it is unavoidable to achieve the Internet connection by utilizing the existing provider's facility.

### SUMMARY OF THE INVENTION

The present invention has been made in order to solve the foregoing problem. It is an object of the present invention to provide a network connection control method and connection control system, which are easily understandable for a user who does not have knowledge concerning the Internet, and moreover, which are capable of minimizing cost when service is provided through the Internet by efficiently utilizing the existing network connection service.

The present invention will be described below. For better understanding of the present invention, reference numerals in the accompanying drawings are enclosed in parentheses, which does not mean that the present invention is limited to an illustrative embodiment.

According to one aspect of the present invention, there is provided a network connection control method, which comprises the processes of:

transferring from a network access server (6) to a first authentication server (7) managed by a first enterprise, user authentication information sent together with a request for making connection to Internet (1) from a user terminal (5) to the network access server managed by the first enterprise providing Internet connection service in association with the network access server;

further transferring the user authentication information, when the user authentication information meets a predetermined condition, from the first authentication server via the Internet to a second authentication server (10) managed by a second enterprise that is different from the first enterprise;

executing user authentication by the second authentication server, referring to a database (15) associated with the second authentication server;

returning the user authentication result to the first authentication server;

notifying, by the first authentication server, the authentication result from the second authentication server to the network access server; and

controlling, by the network access server, whether the Internet connection of the user terminal is enabled or disabled based on the result of the notified user authentication.

According to the present invention, when authentication information on a user making a request for making connection to the network access server managed by the first enterprise meets a predetermined condition, the second authentication server managed by the second enterprise performs user authentication in place of the first authentication server, where, if it is authenticated as a regular user, the network access server of the first enterprise enables Internet connection to such user. Thus, facilities for Internet connection provided by the first enterprise can be used by a user who makes contract with a second enterprise, making it possible to achieve the Internet connection provided by the first enterprise. Which user is enabled to Internet connection can be freely determined between the first and second enterprises, and proper user authentication information may be used by the user based on the contents of such determination. Thus, the user can make the Internet connection without considering the first enterprise. The second enterprise may not provide any facility for Internet connection service, thus making it possible to reduce equipment cost and to dedicate expansion of service provided to the users through the Internet. For the first enterprise, the users acquired by the second enterprise utilize the Internet connection service provided by the first enterprise, thus making it possible to reduce sales cost for user acquisition, and accordingly, to sufficiently increase profit even if a valuable consideration to connection service is discounted.

According to the above described connection control method, the user authentication information may contain an account code for specifying a user, and when the account code contains a predetermined code, the first authentication server may deliver the user authentication information to the second authentication server.

The second enterprise may comprise a server (11, 12, for example) to provide predetermined service over the Internet, and the account code containing the predetermined code may be set as an account code for utilizing the predetermined service provided by the second enterprise over the Internet. By doing this, the Internet connection service access and access of the service provided by the second enterprise via the Internet can be managed by integrated account codes, and service understandable for users can be provided.

A lobby server (11) for providing a chance for searching a negotiation partner to a plurality of users through the Internet may be included as a server for the second enterprise to provide predetermined service over the Internet.

The second enterprise may comprise a server (11, 12, for example) to provide predetermined service over the Internet, a history in which the user has connected to the Internet via the network access server (6) may be detected by a first detecting device managed by the first enterprise, a history in which the user has utilized the service provided by the server of the second enterprise may be detected by a second detecting device (14) managed by the second enterprise, so that an access charge invoiced to the user may be determined based on the detection result of the first and second detecting devices by an accounting information generating device (14) managed by the second enterprise.

By doing this, a charge of the user access to the Internet connection service provided by the first enterprise and a charge of the user access to the service provided by the second enterprise can be invoiced in all. In other words, the second enterprise invoices to the user the account of the first enterprise in place of the first enterprise. Therefore, the access charges are not invoiced individually from each enterprise, and the user confusion can be avoided.

At the step of determining an access charge, if a predetermined discount condition is met, an access charge actually invoiced to the user may be discounted more than that assuming that the discount condition is not met. That is, in the case where the second enterprise collects from a user an access charge for the Internet connection service provided by the first enterprise in place of the first enterprise, there is no need for the first enterprise to manage what invoice is made to the user as long as the access charge can be collected from the second enterprise, and the second enterprise can freely set the contents of invoice to the user irrespective of a charge system of the first enterprise. In this manner, the charge system for utilizing the server of the second enterprise can be set to be attractive to the user.

The “discount” used here denotes a concept including no charge free of invoicing access charge. The predetermined discount condition may be associated with utilization of the user relevant to the service provided by the second enterprise via the server. For example, in the case where the service provider executes product selling or provision of charged service as service provided via the server, it may be judged that the predetermined discount condition is met when a payment for purchasing the product or a charge for accessing the service exceeds a predetermined amount of money. When the service provider provides a charged game as service provided via the server and a point according to a play state relevant to the game is issued to the user, it may be judged whether or not the predetermined discount condition is met based on the point.

According to another aspect of the present invention, there is provided a network connection control system which comprises:

a network access server (6) managed by a first enterprise that provides service for making connection to Internet (1);

a first authentication server (7) managed by the first enterprise in association with the network access server; and

a second authentication server (10) managed by a second enterprise that is different from the first enterprise, the second authentication server being connected to the first authentication server via the Internet, wherein user authentication information sent together with an Internet connection request from a user terminal (5) to the network access server is transferred from the network access server to the first authentication; when the user authentication information meets a predetermined condition, the user authentication information is further transferred to the second authentication server from the first authentication server via the Internet; user authentication is executed by the second authentication server, referring to a database associated with the second authentication server; the user authentication result is returned to the first authentication server; the first authentication server notifies the authentication result from the authentication server to the network access server; and the network access server controls whether the Internet connection of the user terminal is enabled or disabled based on the result of the notified user authentication.

According to this connection control system, an advantageous effect similar to the above described connection control method can be obtained.

According to the connection control system of the present invention, a variety of additional modes may be included in the same way as in the above connection control method.

For example, the user authentication information may contain an account code for specifying a user, and when the account code contains a predetermined code, the first authentication server may deliver the user authentication information to the second authentication server.

The second enterprise may comprise a server (11, 12, for example) to provide predetermined service over the Internet, and the account code containing the predetermined code may be set as an account code for utilizing the predetermined service provided by the second enterprise over the Internet.

A lobby server (11) for providing a change for searching a negotiation partner to a plurality of users through the Internet may be included as the server for the second enterprise to provide predetermined service over the Internet.

The connection control system may comprises: a server (11, 12, for example) for the second enterprise to provide predetermined service over the Internet; a first detecting device managed by the first enterprise, for detecting a history in which the user has connected to the Internet via the network access server (6); a second detecting device (14) managed by the second enterprise, for detecting a history in which the user has utilized the service provided by the server of the second enterprise; and an accounting information generating device (14) managed by the second enterprise, for determining an access charge invoiced to the user is determined based on the detection result of the first and second detecting devices.

When a predetermined discount condition is met, the accounting information generating device may discount an access charge actually invoiced to the user more than that assuming that the discount condition is not met.

The predetermined discount condition may be associated with utilization of the user relevant to the service provided by the second enterprise via the server. For example, in the case where the service provider executes product selling or provision of charged service as the service provided via the server and a payment for purchasing the product or a charge for accessing the service exceeds a predetermined amount of money, the accounting information generating device may judge that the predetermined discount condition is met.

When the service provider provides a charged game as the service provided via the server, and a point according to a play state relevant to the game is issued to the user, the accounting information generating device may judge whether or not the predetermined discount condition is met based on the point.

### BRIEF DESCRIPTION OF THE DRAWINGS

FIG. 1 is a diagram showing a configuration of essential portions of a network to which the present invention is applied;

FIG. 2 is a flow chart showing procedures for user authentication executed by the system of FIG. 1;

FIG. 3 is a flow chart showing procedures for exchanging accounting information executed by the system of FIG. 1; and

FIGS. 4A to 4C are diagrams showing a breakdown of an access charge to be invoiced to a user by a service provider.

### DETAILED DESCRIPTION OF THE INVENTION

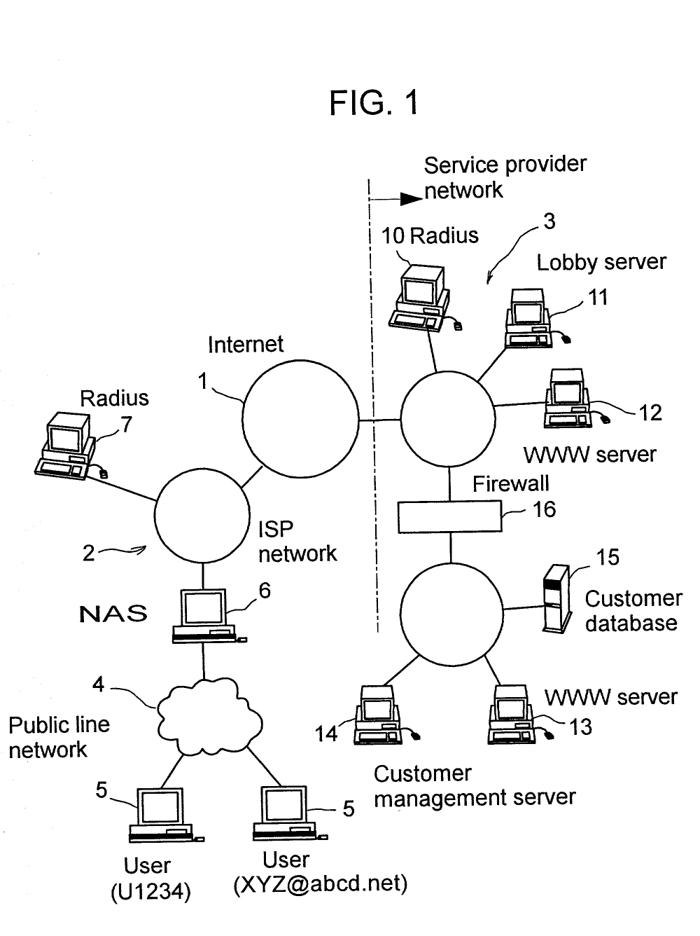

FIG. 1 shows a configuration of a network system to which the present invention is applied. This system comprises Internet 1 and a plurality of networks 2 and 3 connected to the Internet. The networks 2 and 3 are managed by enterprise entities that are different from each other. The network 2 is a network (ISP network) managed by an access provider that provides connection service to the Internet 1, and the network 3 is a network managed by a service provider that attempts to provide specific service through the Internet 1. Although networks of numeral providers are connected to the Internet 1, the access provider shown here is an enterprise that makes contract on authentication service for achieving the system according to the present invention between service providers. In the following description, such access provider may be referred to as a specific access provider. Although a plurality of specific access providers may exist, only the network of one specific access provider is shown in FIG. 1.

To the network 2 of the specific access provider, there are connected a network access server (NAS) 6 for making connection between each of user terminals 5 . . . 5 and the network 2 via a public line network 4 such as telephone line or ISDN line and various servers such as Radius (Remote Authentication Dial In User Service) server for performing user authentication. The NAS 6 is installed at an access point set in various places in sales region (service providing region) for specific access provider, and protocols for dialup IP connection such as PPP or SLIP are supported. The NAS 6 may be referred to as a terminal server. The Radius server 7 is provided for performing integrated user authentication for a plurality of the NAS 6, and the detailed specification is disclosed in RFC (Request for Commends) 2138 and 2139 known as a document connecting the required specification or information in the Internet.

An account code (such as U1234, for example) commonly used in that network 2 and a password paired with the account code are assigned to a user who makes contract with an access provider that manages the network 2. There is a case in which a user can select an account code unless the selected code duplicates that of the other user. A password can be set by the user. To the network 2, there is connected a data base server that stores an account code and a password of the user who makes contract with the access provider, the account code and password being associated with each other. The Radius server 7 performs user authentication utilizing the account code and password according to a request from the NAS 6, and the procedures will be described later.

On the other hand, a Radius server 10 for authenticating a user who makes contract with the service provider is connected to the network 3 managed by the service provider, and a lobby server 11, WWW servers 12 and 13, a customer management server 14, a customer database server 15 or the like are connected to provide predetermined service to a user who makes access via the Internet 1. An account code (for example, XYZ@abcd.net) and password paired with the account code are assigned to a user who makes contract with a service provider. All the account codes provided to the users by the service provider include common characteristics distinguishable from the account code provided to the user by the specific access provider. In the illustrative embodiment, a portion of “@absc.net” is assigned to the end of the account codes of all the users who make contract with the service provider. In the following description, this portion is referred to as a common code. An account code other than common code may be set unless the set account code duplicates that of the other user. A password may be freely set by the user.

The customer database server 15 stores a database in which an account code and a password of a user who makes contract with a service provider is associated with each other. This database may contain user specific information such as user s address, telephone number, credit card number and the like. The Radius server 10 performs user authentication in corporation with the Radius server 7 of the network 2 by utilizing the customer database server 15. The procedures will be described later.

The customer management server 14 is intended for a user who makes contract with a service provider to manage a history utilizing services on the network 3. For example, information for specifying monthly access time of the services on the network 3 by the user, a history in which a file is downloaded on the network 3, user service access charge or the like is recorded in the customer management server 14 in association with account codes by each user.

In order to prevent illegal access from the outside of the network 3 to the customer management server 14 or customer database server 15, a firewall 16 is installed at a proper position in the network 3. Then, as viewed from the Internet 1,the customer management server 14 and customer data base server 15 are installed behind the firewall 16.

The lobby server 11 is intended to provide a common space to a plurality of users who provide access via the Internet 1. For example, a space for finding a partner for chatting or network match-up game is constructed on the lobby server 11. An access to the lobby server 11 can be limited to the registered user in advance. In that case, the lobby server 11 can execute predetermined authentication procedures for a user that access the server itself. For this authentication, there can be utilized the customer database server 15 that the Radius server 10 uses for user authentication. In this way, a common customer database server 15 is used by the Radius server 10 and the lobby server 11, whereby a route for access to the database server 15 is commonly available after exiting the firewall 16. Therefore, possibility that a so-called security hole occurs is lowered, and security is improved as compared with a case in which separate database servers are placed, respectively, for the Radius server 10 and the lobby server 11. In addition, the burdensome maintenance is alleviated by commonly using a database.

In FIG. 1, although the network 3 does not have an access device from the user utilizing the public line network 4 or the like, an access device similar to the NAS 6 of the network 2 may be provided at the network 3 as well.

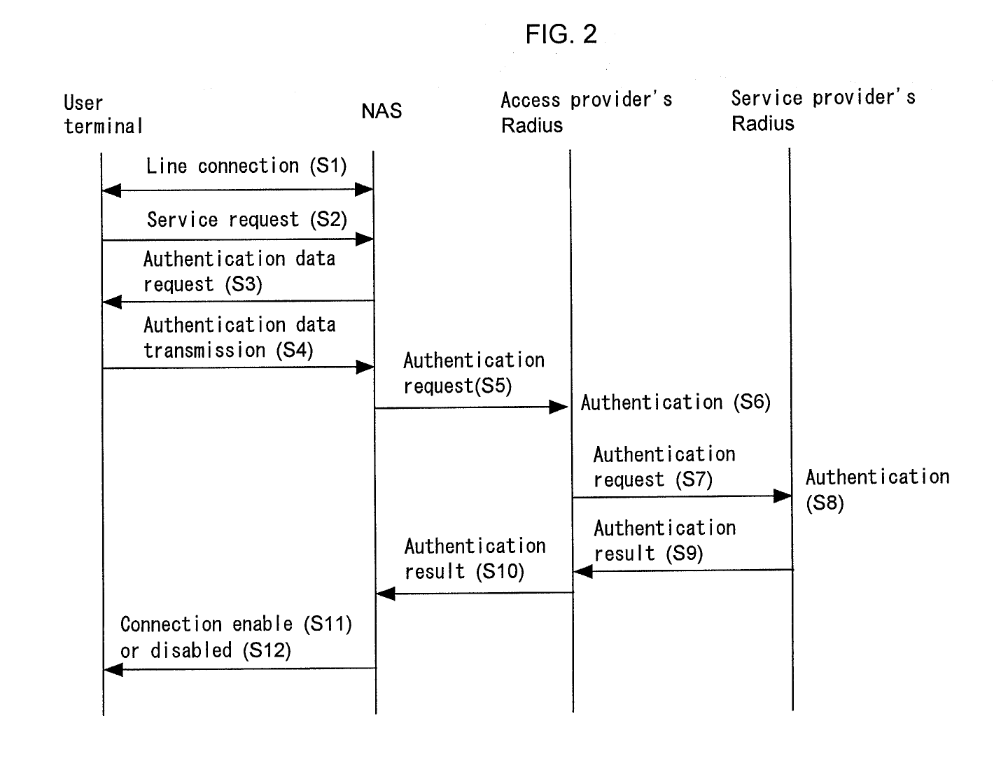

FIG. 2 is a flow chart showing procedures for user authentication utilizing the Radius servers 7 and 10. In the system according to the present invention, there are three cases, i.e., a case in which a user making contract with a specific access provider is connected to the internet 1 via the network 2, a case in which the user making contract with a service provider managing the network 3 is connected to the Internet 1 via the network 2, and a case in which a user who does not make contract with any access provider requests a connection to the network 2.

When the user operates the terminal 5, thereby attempting dialup IP connection to the NAS 6, line connection processing (for example, processing for establishing PPP connection) is performed in accordance with predetermined procedures between the user terminal 15 and the NAS 6 (step S1). When line connection is successful, the user terminal 5 requests the NAS 6 to provide service for making connection to the Internet 1 (step S2), and in response to this request, the NAS 6 requests the user terminal 5 to transmit user authentication data (account code and password, in this case) at step S3. The user terminal 5 transmits the authentication data in response to this request (step S4).

The NAS 6 passes the data to the Radius server 7 upon the receipt of authentication data, and requests the Radius server 7 for user authentication (step S5). The Radius server 7 performs user authentication processing based on the assigned authentication data (step S6). At this time, if the user account code does not contain a common code assigned to the user by the above described service provider (management entity of the network 3), the Radius server 7 provides access to a database server in the network 2, and authenticates whether or not a user requesting connection is a regular user who makes contract with an access provider managing the network 2. In contrast, when the user account code contains such common code, the authentication data is passed to the Radius server 10 of the network 3 via the Internet 1, and user authentication is requested there to (step S7). At this time, encoding procedures determined between the managers of the networks 2 and 3 are utilized for transferring authentication data to prevent the authentication data from being leaked from a node on the Internet 1 to a third person.

Upon the receipt of authentication data via the network 2, the Radius server 10 provides access to the customer database server 15, and performs user authentication (step S8). In this authentication, it is checked whether or not a user requesting access is a user who makes contract with a service provider according to whether or not a pair of account code and password is registered in the database on the customer database server 15. When authentication terminates, the Radius server 10 notifies the authentication result (whether or not the user can be checked) to the Radius server 7 of a specific access provider (step S9). Then, the Radius server 7 notifies the result authenticated by the server itself or Radius server 10 to the NAS 6 (step S10).

Upon the receipt of the authentication result, in the case where the user is checked by the Radius server 7 or 10, the NAS 6 enables connection between the user terminal 5 and the Internet 1 (step S11), and when the user is not checked by neither the Radius server 7 nor 10, it disables connection between the user terminal 5 and the Internet 1 (step S12). In the case where connection is enabled, a user access state is monitored by a customer management server (not shown) connected to the network 2 of the access provider until the subsequent disconnection has been made, and the information according to the access state is recorded on the customer management server. This customer management server is intended for management of the users who make contract with an access provider. This server executes processing in a manner similar to the customer management server 14 of the service provider 3, and functions as a first detecting device according to the present invention. However, the connection position is changed according to the circumstance of the network 2 of the access provider as required.

According to the system as described above, a user who desires to utilize service of the network 3 merely makes contract with a service provider and acquires an account code containing the foregoing common code, thereby making it possible to utilize service for making connection to the Internet 1 and service over the network 3. Thus, there is no need for user to make additional contract with the specific access provider. Therefore, even a user who does not have knowledge on Internet can utilize service over the network 3 easily.

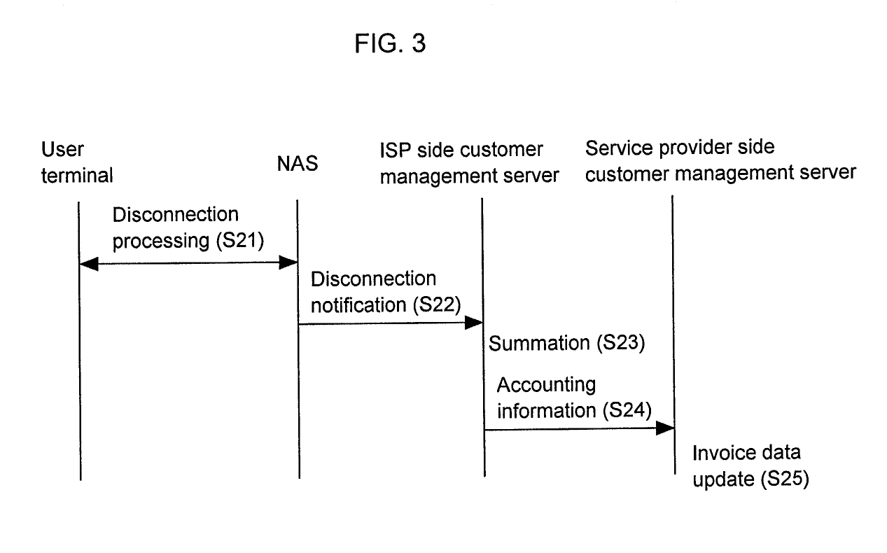

In the meantime, in the above described system, a cost for the user making contract with a service provider to make connection to the Internet 1 occurs at the specific access provider, and a cost utilizing service over the network 3 occurs at the service provider. The specific access provider and service provider are required to collect from users an amount of money according to the produced cost being a payment to service. However, if the specific access provider and service provider invoice access charges to the users individually, the user will be confused because only such invoice from the specific access provider is notified even though the user does not make contract with the specific access provider. To avoid such confusion, it is desirable that the specific access provider notifies to the service provider a history of access to dialup IP connection of the user making contract with the service provider, the service provider adds a cost according to a history of services over the network 3 in response to this, and the access charge is invoiced to the user in all. FIG. 3 is a flow chart showing an example of procedures for performing such processing.

FIG. 3 shows an example of processing when a disconnection reason occurs at the user terminal 5 or the specific access provider, where processing for making disconnection from the Internet 1 is performed between the terminal 5 and the NAS 6 (step S21). When disconnection processing terminates, the NAS 6 notifies such disconnection to the customer management server over the network 2 (step S22). Upon the receipt of this notification, the customer management server over the network 2 sums the user access times (step S23), and transmits the summation result being accounting information to the customer management server 14 of the service provider (step S24). Upon the receipt of this transmission, the customer management server 14 updates data which is a base of invoicing the access charge concerning the corresponding user (step S25). The customer management server 14 sums an amount of money for access charge concerning the corresponding user based on the thus updated data, computes an amount of money invoiced to each user periodically (monthly, for example) based on the summation result, and outputs it to a predetermined output destination (for example, printer at which an invoice form is set). In FIG. 3, although every access state is notified to the service provider every time the user terminates connection to the Internet 1, the access provider may notify the access state of each user to the service provider in all every predetermined period (for example, monthly). Of course, a substituent settlement using a credit company or the like may be utilized for invoicing the access charge to the user. In this case, the customer management server 14 may transmit the access charge of each user to a computer for card company settlement.

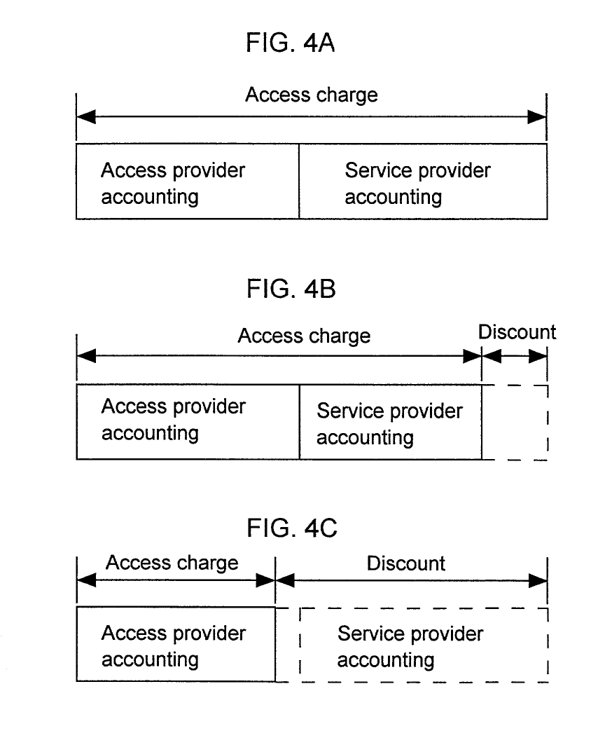

In the foregoing processing, the service provider makes a payment to the specific access provider (accounting caused by the specific access provider) according to the access history of dialup IP connection service notified from the specific access provider, whereas an amount of money obtained by adding an account caused by the specific access provider and an account according to the access history of its own provided service is collected from the users, the amount being an access charge (refer to FIG. 4A). In this case, the specific access provider may collect from the service provider a payment to provision of dialup IP connection service, and may not manage how the service provider makes invoice to the user. Therefore, the service provider can make an access charge to a user by setting a free charge system without being constricted to a charge system set by the specific access provider for its contractor.

For example, when a user meets a predetermined condition, the service provider can reduce a charge payment to the user by discounting an account of the service provider, as shown in FIG. 4B. In this case, the predetermined condition requires that the user is a member of network service managed by the service provider with paying a predetermined membership fee. In the case where the service provider sells a product or provides charged service (for example, provides a variety of information) over the network 3, if a payment for purchase of such product or service access charge exceeds a predetermined amount of money, the discount condition may be met. In the case where the service provider provides a charged game over the network 3, a point is issued to the user according to the achievement of the game (or progress). Even if that point is accumulated over a predetermined value, the discount condition may be met. When the game access time is equal to or more than a predetermined value, the discount condition may be met. It is judged whether or not a predetermined condition is met when the access charge of each user is computed at the customer management server 14, for example. When the condition is met, the computation amount of access charge may be operated.

The degree of discount may be changed stepwise according to an amount of money for product purchase, game achievement point and the like, and finally the service provider's account may be set to be free. Further, as shown in FIG. 4C, discount may be expanded to the specific access provider's account.

According to the above system, there is no need for the service provider to provide a number of facilities (such as NAS 6) for providing service for making connection to the Internet 1, and a burden on the service provider relevant to equipment cost is very small. On the other hand, for the specific access provider, the number of users accessing its own dialup IP connection is increased by sales activity of the service provider, and thus, sales running cost for user acquisition can be reduced. Therefore, there is an advantage that the specific access provider can provide service for making connection to the Internet 1 at more reasonable cost than usual while ensuring reasonable profits. Further, if the service provider makes contract with a plurality of specific access providers, the user has more selections concerning connection environment such as access point, accounting mode, or communication speed, and various internet connection services can be provided to various users according to their preferences.

According to the present invention, there may be provided a network connection control method for providing to a predetermined authentication device, user authentication information sent together with a request for making connection to the Internet from a user terminal to a network access server managed by a first enterprise that provides Internet connection service to authenticate a user, notifying the authentication result to the network access server, and controlling, by the network access server, whether the user terminal enables or disables Internet connection based on the result of the notified user authentication, the connection control method comprising a server for the second enterprise to provide predetermined service over the Internet, wherein a first detecting device managed by the first enterprise detects a history in which the user has connected to the Internet via the network access server, a second detecting device managed by the second enterprise detects a history in which the user has accessed the service provided by the server of the second enterprise, and an accounting information generating device managed by the second enterprise determines an access charge invoiced to the user based on the detection result of the first and second detecting devices.

Alternatively, according to the present invention, there may be provided a network connection control system comprising: a network access server managed by a first enterprise that provides Internet connection service; and an authentication device for executing user authentication based on user authentication information sent together with a request for making connection from a user terminal to the Internet relevant to the network access server, and notifying the authentication result to the network access server, the network access server controlling whether the user terminal enables or disables user terminal Internet connection based on the notified authentication result from the authentication device, the network connection control system further comprising: a server for the second enterprise to provide predetermined service over the Internet; a first detecting device managed by the first enterprise, for detecting a history in which the user has connected to the Internet via the network access server; a second detecting device managed by the second enterprise, for detecting a history in which the user has accessed the service provided by the server of the second enterprise; and an accounting information generating device managed by the second enterprise, for determining an access charge invoiced to the user based on the detection result of the first and second detecting devices.

According to the above illustrative embodiment, there is provided invention regarding a method for invoicing together an Internet connection service access charge and an access charge for network service provided via the Internet, wherein when the network service access state meets a predetermined discount condition, at least either one of the connection service access charge and the network service access charge can be discounted. Also, the above embodiment comprises invention regarding an accounting control device for invoicing together the connection service access charge and an access charge of network service provided via the Internet in all, and the system also comprises a device for discriminating whether or not the network service access state meets a predetermined discount condition, the accounting control device for, when the discount condition is met, discounting at least either one of the connection service access charge and the network service access charge. The network services used here include a variety of services available from the user terminal through the Internet such as product selling, provision of charged service such as information distribution, and playing a game, for example. The predetermined discount conditions used here can be defined based on an amount of money for product purchase or service access, the achievement of a game, a game playing time or the like, and the discounting may be performed at a plurality of stages.

As has been described above, according to the present invention, the Internet connection can be achieved for a user who makes contract a second enterprise by utilizing Internet connection service provided by a first enterprise. Which user is enabled for Internet connection can be freely determined between the first and second enterprises. Proper user authentication information is made available for users based on the determination contents. Thus, a user can make Internet connection without considering the first enterprise, and service understandable to users can be provided. In the case where the second enterprise provides any service by utilizing a server over the Internet, the second enterprise may not provide any facility for providing Internet connection service. Thus, the second enterprise can reduce equipment cost, and dedicate expansion of service provided through the Internet. For the first enterprise, the users acquired by the second enterprise utilize its own Internet connection service. Thus, the first enterprise can reduce sales running cost for user acquisition, and accordingly, can increase profits sufficiently even if a payment to connection service is discounted.

What is claimed is:

1. A network connection control method, comprising the processes of:
transferring from a network access server to a first authentication server managed by a first enterprise, user authentication information sent together with an Internet connection request from a user terminal to the network access server managed by a first enterprise providing Internet connection service in association with the network access server;
further transferring the user authentication information, when the user authentication information meets a predetermined condition, from the first authentication server via the Internet to a second authentication server managed by a second enterprise that is different from the first enterprise;
executing user authentication by the second authentication server, referring to a database associated with the second authentication server;
returning the user authentication result to the first authentication server;
notifying, by the first authentication server, the authentication result from the second authentication server to the network access server; and
controlling, by the network access server, whether Internet connection of the user terminal is enabled or disabled based on the result of the notified user authentication.

2. The connection control method according to claim 1, wherein, the user authentication information contains an account code for specifying a user, and when the account code contains a predetermined code, the first authentication server delivers the user authentication information to the second authentication server

3. The connection control method according to claim 2, comprising a server for the second enterprise to provide predetermined service over the Internet, wherein the account code containing the predetermined code is set as an account code for utilizing the predetermined service provided by the second enterprise over the Internet.

4. The connection control method according to claim 1, wherein a lobby server for providing a chance for searching a negotiation partner to a plurality of users through the Internet is included as a server for the second enterprise to provide predetermined service over the Internet.

5. The connection control method according to claim 1, comprising a server for the second enterprise to provide predetermined service over the Internet, wherein a history in which the user has connected to the Internet via the network access server is detected by a first detecting device managed by the first enterprise, a history in which the user has utilized the service provided by the server of the second enterprise is detected by a second detecting device managed by the second enterprise, and an access charge invoiced to the user is determined based on the detection result of the first and second detecting devices by an accounting information generating device managed by the second enterprise.

6. The connection control method according to claim 5, wherein, when a predetermined discount condition is met, an access charge to be actually invoiced to the user is discounted more than that assuming that the discount condition is not met.

7. The connection control method according to claim 6, wherein the predetermined discount condition is associated with utilization of the user relevant to the service provided by the second enterprise via the server thereof.

8. The connection control method according to claim 7, wherein, in the case where the service provider executes product selling or provision of charged service as service provided via the server thereof, and a payment for purchasing a product or a charge for accessing the charged service exceeds a predetermined amount of money, it is judged that the predetermined discount condition is met.

9. The connection control method according to claim 7, the service provider provides a charged game as service provided via the server thereof and issues to the user a point according to a play state relevant to the game, and based on the point, it is judged whether or not the predetermined discount condition is met.

10. A network connection control system comprising:
a network access server managed by a first enterprise that provides Internet connection service;
a first authentication server managed by the first enterprise in association with the network access server; and
a second authentication server managed by a second enterprise that is different from the first enterprise, the second authentication server being connected to the first authentication server via Internet,
wherein user authentication information sent together with an Internet connection request from a user terminal to the network access server is transferred from the network access server to the first authentication server; when the user authentication information meets a predetermined condition, the user authentication information is further transferred to a second authentication server from the first authentication server via the Internet; user authentication is executed by the second authentication server, referring to a database associated with the second authentication server; the user authentication result is returned to the first authentication server; the first authentication server notifies the authentication result from the second authentication server to the network access server; and the network access server controls whether Internet connection of the user terminal is enabled or disabled based on the result of the notified user authentication.

11. The network connection control system according to claim 10, wherein the user authentication information contains an account code for specifying the user, and the first authentication server delivers the user authentication information to the second authentication server when the account code contains a predetermined code.

12. The network connection control system according to claim 11, comprising a server for the second enterprise to provide predetermined service over the Internet, wherein the account code containing the predetermined code is set as an account code for utilizing the predetermined service provided by the second enterprise over the Internet.

13. The network connection control system according to claim 10, wherein a lobby server for providing a chance for searching a negotiation partner to a plurality of users through the Internet is included as a server for the second enterprise to provide predetermined service over the Internet.

14. The network connection control system according to claim 10, comprising: a server for the second enterprise to provide predetermined service over the Internet; a first detecting device managed by the first enterprise, for detecting a history in which the user has connected to the Internet via the network access server; a second detecting device managed by the second enterprise, for detecting a history in which the user has utilized the service provided by the server of the second enterprise; and an accounting information generating device managed by the second enterprise, for determining an access charge invoiced to the user based on the detection result of the first and second detecting devices.

15. The network connection control system according to claim 14, wherein, when a predetermined discount condition is met, the accounting information generating device discounts an access charge actually invoiced to the user more than that assuming that the discount condition is not met.

16. The network connection control system according to claim 15, wherein the predetermined discount condition is associated with utilization of the user relevant to the service provided by the second enterprise via the server thereof.

17. The network connection control system according to claim 16, wherein, in the case where the service provider executes product selling or provision of charged service as service provided via the server thereof, and a payment for purchasing the product or a charge for accessing the charged service exceeds a predetermined amount of money, the accounting information generating device judges that the predetermined discount condition is met.

18. The network connection control system according to claim 16, wherein, when the service provider provides a charged game as service provided via the server thereof, and issues to the user a point according to a play state relevant to the game, and based on the point, the accounting information generating device judges whether or not the predetermined discount condition is met.
